(19) United States
(12) Patent Application Publication
(10) Pub. No.: US 2011/0313911 A1
(43) Pub. Date: Dec. 22, 2011

(54) Loan management software system and method

(75) Inventor: Gregg Marcus, Brookville, NY (US)

(73) Assignee: Support Savvy, LLC

(21) Appl. No.: 12/802,963

(22) Filed: Jun. 17, 2010

(51) Int. Cl. G06Q 40/00

(52) U.S. Cl. 705/38; 705/35

(57) ABSTRACT

A management software system and method for mortgage banking lead and pipeline management and business/compliance rules enforcement.

### FIELD OF THE INVENTION

The present invention relates to a management software system and for mortgage banking lead and pipeline management and business/compliance rules enforcement.

### BACKGROUND OF THE INVENTION

US patent publication 2007/0067234 relates to a system and method for qualifying and selecting mortgage loans for a borrower. The method includes the operation of collecting mortgage loan information from the borrower. The system obtains credit information from the borrower via a network based on the mortgage loan information. The combined mortgage loan information and credit information can be compared with the conditions of a plurality of mortgage loan programs offered by a mortgage supplier. The comparison can generate a qualified active listing of mortgage loan programs from a plurality of mortgage loan programs.

U.S. Pat. No. 7,415,471 relates to methods and systems for automated data collection and analysis for use in association with asset securitization. The method includes reviewing asset-related data contained on at least one document, receiving the asset document into the database on a flow basis, analyzing the contents of the asset document to ensure compliance with at least one standard, and providing output data from the record in said database.

US patent 2004/0220885 relates to a method and system for managing and preparing documentation for real estate transfers and financing, including a system for preparation, production and storage of relevant documentation and the data contained herein; a system for coordinating, reconciling and transferring funds; and a system of analyzing and tracking the progress of numerous real estate transactions. A closing package can be compiled which contains electronic versions of any document needed for closing a real estate transaction. Also included are scheduling features for coordinating one or more real estate transactions and management reporting for keeping track of a plurality of real estate transactions.

US patent publication 2004/0078296 relates to a system and method for transmitting and processing loan data. The system includes a server which receives loan data, from lenders and stores the loan data in a database. A web server provides to users, brokers, correspondents, or retail loan customers, interactive web content including loan information and a list of loan criteria which would affect the quoted points, rate, cap, or margin associated with a particular loan. The web server receives a user's applicable loan criteria selected from the list of particular loan criteria, and uses that particular loan criteria and the loan data from the lender to create a list of adjustments to the points, rate, cap, or margin. A quoted interest rate and the list of applicable adjustments are transmitted by the web server to the user.

US patent publication 2004/0215552 relates to a system and method for electronically managing and approving a loan application. The apparatus may include a document administration module, a loan officer module, an underwriting module, and an administration module, with each of the modules interacting with one another. At least one of the modules operates on a document, and a plurality of the modules may simultaneously operate on the loan application. The method may receive a loan application, generate an indication of the document required to approve the loan application, electronically receive the document, store the document, provide access to the document, and in response to electronically underwriting the document, approve the loan application.

U.S. Pat. No. 6,904,412 relates to a method and apparatus for a mortgage loan originator compliance engine. The engine uses the federal, state, local and professional regulations and requirements and implementing instructions to generate a plurality of tasks which can be used to control and drive the process of handling a mortgage loan application to completion and to monitor the completion of the tasks in order to generate a Completion Certificate.

U.S. Pat. No. 7,461,020 relates to a system and method for creating and tracking agreements for selling loans to a secondary market purchaser. The system creates an agreement and tracks compliance with terms of an agreement between a seller and a purchaser for the sale of loans includes deal management logic and a rules processor. The deal management logic is configured to store and track terms of the agreement using a set of business rules. The system may also include pricing logic that is configured to create a set of price data based on at least one term of the agreement.

U.S. Pat. No. 7,593,889 relates to a system and method for processing data pertaining to financial assets, comprising acquisition logic, reporting logic, and financial asset generation logic. The acquisition logic is configured to receive information pertaining to loan term, interest rate, principal owed and other parameters for a plurality of loans. The reporting logic is configured to receive payment information regarding borrower payments in connection with the plurality of loans. The financial asset generation logic is configured to facilitate creation and maintenance of a plurality of financial assets backed by the plurality of loans. They are all provided on a common integrated data processing platform.

U.S. Pat. No. 7,395,239 relates to a system and method for automatically processing loan applications, secured buy real estate, wherein an applicant is prompted for one or more parameters of a requested loan and for data regarding the applicant, data regarding applicant's credit is accessed based on data provided by the applicant, predetermined rules are applied to the received data. It is automatically determined whether to approve the loan based on the results of the application of the predetermined rules to the received data. If the loan is approved, one or more terms of the loan are automatically determined based on the results of the application of the predetermined rules to the received data. The applicant is informed whether the loan was approved and one or more terms of the loan, if approved.

US patent publication 2005/0289046 relates to a system and method for facilitating realtor-assisted loan shopping and origination. The system allows professionals in close proximity to the mortgage transaction to actively participate in the transaction. The system allows realtors to track the loan origination progress for multiple borrowers to active to approved to floating to locked to close. The system allows the realtor to monitor commission pipelines. The system tracks the relationship of a branch manager or broker, with real estate agents who work for that branch manager.

### SUMMARY OF THE INVENTION

The present invention relates to a management software system designed for mortgage banking lead and pipeline management and business/compliance rules enforcement. It is an object of the present invention for the system to have virtually unlimited reporting capability, including financial reporting. It is an object of the present invention for the system to enable paperless operations and electronic document and loan file storage.

It is an object of the present invention to enhance companywide communication and customized distribution groups via email for messages, alerts, and notification.

It is an object of the present invention for the system to be Sequel based system which is configured to overlay on top of any loan origination system (LOS) and most accounting software systems.

It is an object of the present invention for the system to support the mortgage banker's lead distribution and follow up, providing tremendous efficiency and marketing dollar ROI enhancement. It is an object of the present invention to identify efficient loan officers and monitor sales productivity.

It is an object of the present invention for the system to provide pipeline management and customize business rule enforcement. The business rule enforcement, aside from credit risk management and enforcing internal policies, is a valuable and necessary compliance check and balance, and the customization ensures that constant regulatory changes are accommodated.

It is an object of the present invention for the system to be configured with financial reporting and overlay atop virtually any accounting software.

It is an object of the present invention for the system to allow dashboard management reporting and auto reporting.

It is an object of the present invention for the system to integrate a mortgage bankers Outlook email system into the custom designed notifications and messages/alerts that the system auto generates as directed and configured to match the company organization chart and departmental structures and roles.

It is an object of the present invention for the system to be written utilizing Microsoft's .NET framework. It is an object of the present invention for the system to be a fully web based system with a SQL database on the back end. It is an object of the present invention for the system to be an overlay for a Mortgage Banker's Loan Origination System. Functionality in most, if not all LOS systems is finite and cannot be customized to meet a mortgage banker's workflow needs.

It is an object of the present invention for the system to be fully customizable to meet the needs of the mortgage banker and the changes in the industry. The system of the present invention was built using architecture of separate modules to provide cradle to give management control and infinite flexibility.

The present invention comprises a data importer which comprises a module which runs on a server or computer and is responsible for extracting the defined data from the LOS to loan production system SQL database. The data importer uses a mapping of fields defined by the system administrator.

It is an object of the present invention for the module to allow conditions or stipulations to be added to a loan. A condition type, when it needs to be satisfied, and who the condition is meant for are assigned to each condition. It is an object of the present invention for each condition to be time stamped when added. It is an object of the present invention for the required document for each condition to be uploaded directly to the condition, which works with all the attachments module. It is an object of the present invention for an email alert to be sent to all parties on the loan. It is an object of the present invention for an underwriter to either reject, receive or clear the document. All of which are time stamped. Templates are built by an administrator utilizing the conditions admin module. It is an object of the present invention for the administrator to specify access for each user to receive, clear, or delete conditions.

It is an object of the present invention for the system to comprise an conditions admin. The conditions admin allows an administrator to create templates of conditions which a user can apply to a loan to speed up the process rather than select each condition. It is an object of the present invention for access to be given to this module for each user by the system administrator.

It is an object of the present invention for the system to comprise an attachments module. The attachments module is a container for all scanned images for a loan. It is an object of the present invention for an image to be uploaded directly to a condition where it is linked to that condition. It is an object of the present invention for a document to be uploaded using a dropdown list which is maintained by the system administrator. It is an object of the present invention for access to be applied by the system administrator to allow or disallow users from viewing certain documents. It is an object of the present invention for Email alerts to be configured for certain document uploads by the administrator.

It is an object of the present invention for the system to comprise a Compliance/Business Rules/Signoffs module.

The compliance/business rules/signoffs module verifies all data for approval, closing and funding to the borrower. It is an object of the present invention for the module to have Validation which includes State subprime rules, HVCC (Home Value Code of Conduct), HMDA (Home Mortgage Disclosure Act), MDIA (Mortgage Disclosure Improvement Act) loan officer state licensing, etc. It is an object of the present invention for warnings to be displayed for certain business rules. It is an object of the present invention for Email alerts to be sent to all parties on the loan and any additional admin configured addresses when signoff is completed. It is an object of the present invention for appraisal signoffs to be included in this module. It is an object of the present invention for all data for the loan to be summarized on this page as well as in the email alerts. It is an object of the present invention for a snapshot of the page to be attached to the loan in attachments and e-mailed to all parties on the loan once a signoff is completed.

It is an object of the present invention for the system to comprise a refer decision module.

The refer decision module comprises a worksheet to send a loan for review by committee when an underwriter cannot make a final decision on the loan. It is an object of the present invention for the worksheet to be saved in attachments and emailed to designated management for further review and decision making.

It is an object of the present invention for the system to comprise an appraisal review module.

The appraisal review module is a full appraisal review worksheet. It is an object of the present invention for the module to include appraisal conditions, property information, etc. It is an object of the present invention for a copy of the appraisal review to get attached to the loan as well as emailed to the appropriate parties on the loan.

It is an object of the present invention for the system to comprise a title review module.

The title review module is a full title review worksheet with title issues, deed information, departmental, etc. It is an object of the present invention for the title review module to get attached to the loan in attachments and emailed to the appropriate parties on the loan, once completed.

It is an object of the present invention for the system to comprise a HVCC (Home Value Code of Conduct) module.

The HVCC module is for tracking when an appraisal was sent to the borrower and how it was sent. The calculation is used on the Closing Schedule, which is another module listed below.

It is an object of the present invention for the system to comprise a compliance tracking module.

The compliance tracking module is for tracking when the disclosure documents are sent and when the loan can proceed, and/or when significant events can occur within the loan cycle (money can be collected for an appraisal or other service from the borrower, etc).

It is an object of the present invention for the system to comprise a closing schedule module.

The closing schedule module is used to add and remove loans from the Closing Schedule report. It is an object of the present invention for the closing schedule module to be color coded to coordinate the various outcomes of a closing. (Ex. Closed, Released, Rescinded, Adjourned). It is an object of the present invention for the HVCC rules to be built into the report.

It is an object of the present invention for the system to comprise a rate lock module.

The rate lock module is used by the lock desk for tracking which investor the loan is locked with. It is an object of the present invention for this module to include the date it was locked, the date the lock expires, the trade, what the market was at the time, etc. It is an object of the present invention for the rate lock information to be transposed onto the signoff for the loan officer and all parties to see. It is an object of the present invention for the module to have an associated rate lock report displaying all loans not sold to an investor with the rate lock expiration information.

It is an object of the present invention for the system to comprise a secondary module.

The secondary module is limited to only users given access by an administrator. It is an object of the present invention for this module to track multiple investor's pricing with a full breakdown as follows:

Base Price+Adjustments+SRP+Additional Premium=Price Price−Margin=Loan Officer Price

It is an object of the present invention for the system to comprise a settlement module.

The settlement module tracks the warehouse information for closed loans. It is an object of the present invention for this module to also track all monthly mortgage payments, next due date, monthly escrow for taxes and insurance and late payment information while interim servicing.

It is an object of the present invention for the system to comprise a post closing module.

The post closing module tracks the loan from closing to sale to an investor. It is an object of the present invention for this module to include closing, electronic delivery, assignment, recording, etc. information. It is an object of the present invention for all information to be shown on a report for assigned users to view for tracking the sale of all loans.

It is an object of the present invention for the system to comprise a funding module.

The funding module captures the sale date and pricing to the investor. This information is used to calculate corporate revenue reports. It is an object of the present invention for user access for this module to be assigned by the administrator.

It is an object of the present invention MIC module.

The MIC module tracks FHA case binders delivered to HUD. It is an object of the present invention for this module to include the HUD office, the date it was shipped and the date it was insured.

It is an object of the present invention for each of the modules to interact with one another. It is an object of the present invention for the modules to simultaneously operate on a loan document.

It is an object of the present invention for the modules to comprise computer executable instructions.

It is an object of the present invention for each module to comprise an independent software application accessible by the user.

It is an object of the present invention for each module to share common files.

It is an object of the present invention for each module to have access separately to each of the files in the system.

The present invention relates to a method for managing loans comprising: extracting data from a loan origination system and placing the data in a loan production system; adding conditions or stipulations to the loan; checking that the loan complies with regulatory changes through a business rule enforcement system; and verifying data for approval, closing and funding to a borrower.

It is an object of the present invention for the method to further comprise allowing or disallowing access to users for viewing certain documents in the loan production system.

It is an object of the present invention for the method to further comprise: identifying efficient loan officers and monitoring sales productivity.

It is an object of the present invention for the method to further comprise: integrating an Outlook email system into custom designed notifications and messages/alerts that the system auto generates as directed and configured to match company organization chart and departmental structures and roles.

It is an object of the present invention for the method to comprise: creating templates of conditions which a user applies to a loan to speed up process rather than select each condition.

It is an object of the present invention for the method to further comprise: tracking when disclosure documents are sent and when loan can proceed, and/or when significant events, money collected for appraisal or other service from borrower, occurs within loan cycle.

It is an object of the present invention for the method to further comprise: adding and removing loans from a closing schedule report.

It is an object of the present invention for the method to further comprise: tracking which investor a loan is locked with, and tracking multiple investor's pricing with a full breakdown.

It is an object of the present invention for the method to further comprise: tracking all monthly mortgage payments, next due date, monthly escrow for taxes and insurance and late payment information while interim servicing.

It is an object of the present invention for the method to further comprise: tracking loans from closing to sale to an investor.

It is an object of the present invention for the method to further comprise: calculating corporate revenue reports.

It is an object of the present invention for the method to further comprise: tracking FHA case binders delivered to HUD.

It is an object of the present invention for the method to further comprise: sending email alerts to all parties on a loan.

### DETAILED DESCRIPTION OF THE INVENTION

The present invention relates to a management software system designed for mortgage banking lead and pipeline management and business/compliance rules enforcement. The loan production system has virtually unlimited reporting capability, including financial reporting, and enabling paperless operations and electronic document and loan file storage.

The system enhances companywide communication and customizes distribution groups via email for messages, alerts, and notification. In a preferred embodiment, the system is a Sequel based system which can be configured to overlay on top of any Loan Origination system and most accounting software systems.

The system supports the mortgage banker's lead distribution and follow up, providing tremendous efficiency and marketing dollar ROI enhancement. It is very valuable in identifying efficient loan officers and monitoring sales productivity. The system provides pipeline management and allows customized business rule enforcement. The business rule enforcement, aside from credit risk management and enforcing internal policies, is a valuable and necessary compliance check and balance, and the customization ensures that constant regulatory changes can be accommodated. In a preferred embodiment, the system is configured with financial reporting and overlays atop virtually any accounting software.

In an embodiment, the system allows dashboard management reporting and auto reporting.

In an embodiment, the system integrates a mortgage bankers Outlook email system into the custom designed notifications and messages/alerts that the system auto generates as directed and configured to match the company organization chart and departmental structures and roles

In an embodiment, the loan production system is written utilizing Microsoft's .NET framework. The system is a fully web based system with a SQL database on the back end. In an embodiment, the system is an overlay for a Mortgage Banker's Loan Origination System (LOS). Functionality in most, if not all LOS systems is finite and cannot be customized to meet a mortgage banker's workflow needs. The system of the present invention is fully customizable to meet the needs of the mortgage banker and the changes in the industry. It was built using architecture of separate modules to provide cradle to give management control and infinite flexibility.

The system of the present invention comprise modules which contains data from a database in the system. The data importer is a module that runs on a server or computer and is responsible for extracting the defined data from the LOS to LPS' SQL database. The data importer uses a mapping of fields defined by the system administrator.

In an embodiment, the system of the present invention comprises a conditions module which allows conditions or stipulations to be added to a loan, a condition type, when it needs to be satisfied, and who the condition is meant for, are assigned to each condition. In a preferred embodiment, each condition is time stamped when added. The required document for each condition can then be uploaded directly to the condition, which works with the attachments module of the system. In an embodiment, an email alert is sent to all parties on the loan. The document can then be rejected, received and cleared by the underwriter. All of these documents are then time stamped.

In an embodiment, templates are built by an administrator utilizing the conditions admin module. The administrator can specify access for each user to receive, clear, or delete conditions.

In an embodiment, the system comprises a conditions Admin module. This module allows an administrator to create templates of conditions which a user can apply to a loan to speed up the process rather than select each condition. Access is given to this module for each user by the system administrator.

In an embodiment, the system comprises an attachments module. This module is a container for all scanned images for a loan. An image can be uploaded directly to a condition where it is linked to that condition. A document can also be uploaded using a dropdown list which is maintained by the system administrator. Access can be applied by the system administrator to allow or disallow users from viewing certain documents. Email alerts can be configured for certain document uploads by the administrator.

In an embodiment, the system comprises a compliance/business rules/signoffs module. This module verifies all data for approval, closing and funding to the borrower. Validation includes State subprime rules, HVCC (Home Value Code of Conduct), HMDA (Home Mortgage Disclosure Act), MDIA (Mortgage Disclosure Improvement Act) loan officer state licensing, etc. Warnings are displayed for certain business rules. Email alerts are sent to all parties on the loan and any additional admin configured addresses when signoff is completed. Appraisal signoffs are included in this module. All data for the loan is summarized on this page as well as in the email alerts. Once a signoff is completed, a snapshot of the page gets attached to the loan in attachments and emailed to all parties on the loan.

In an embodiment, the system comprises a refer decision module. This module contains a worksheet to send a loan for review by committee when an underwriter cannot make a final decision on the loan. The worksheet is saved in attachments and emailed to designated management for further review and decision making.

In an embodiment, the system comprises an appraisal review module. This module is a full appraisal review worksheet. This includes appraisal conditions, property information, etc. Once saved a copy gets attached to the loan as well as emailed to the appropriate parties on the loan.

In an embodiment, the system comprises a title review module. This module is a full title review worksheet with title issues, deed information, departmental, etc. Once completed, it gets attached to the loan in attachments and emailed to the appropriate parties on the loan.

In an embodiment, the system comprises a HVCC (Home Value Code of Conduct) module. This module tracks when an appraisal was sent to the borrower and how it was sent. The calculation is used on the Closing Schedule, which is another module listed below.

In an embodiment, the system comprises a compliance tracking module. This module tracks when the disclosure documents are sent and when the loan can proceed, and/or when significant events can occur within the loan cycle (money can be collected for an appraisal or other service from the borrower, etc).

In an embodiment, the system comprises a closing schedule module. This module adds and removes loans from the Closing Schedule report. In a preferred embodiment, the closing schedule is color coded to coordinate the various outcomes of a closing. (Ex. Closed, Released, Rescinded, Adjourned). HVCC rules are built into the report.

In an embodiment, the system comprises a rate lock module. This module is used by the lock desk for tracking which investor the loan is locked with. It includes the date it was locked, the date the lock expires, the trade, what the market was at the time, etc. The rate lock information is transposed onto the signoff for the loan officer and all parties to see. There is also an associated rate lock report displaying all loans not sold to an investor with the rate lock expiration information.

In an embodiment, the system comprises a secondary module which is limited to only users given access by an administrator. This module tracks multiple investor's pricing with a full breakdown as follows:

Base Price+Adjustments+SRP+Additional Premium=Price Price−Margin=Loan Officer Price

In an embodiment, the system comprises a settlement module. This module tracks the warehouse information for closed loans. It also tracks all monthly mortgage payments, next due date, monthly escrow for taxes and insurance and late payment information while interim servicing.

In an embodiment, the system comprises a post closing module. This module tracks the loan from closing to sale to an investor. It includes closing, electronic delivery, assignment, recording, etc. information. All information is shown on a report for assigned users to view for tracking the sale of all loans.

In an embodiment, the system comprises a funding module. This module captures the sale date and pricing to the investor. This information is used to calculate corporate revenue reports. User access for this module is assigned by the administrator.

In an embodiment, the system comprises an MIC module. This module tracks FHA case binders delivered to HUD. It includes the HUD office, the date it was shipped and the date it was insured.

1. A management software system for mortgage banking leads, pipeline management and business/compliance rules enforcement comprising:
separate modules or databases which provide management control;
a business rule enforcement system which is a compliance check and balance system and insures regulatory changes are made within a loan production system;
a data importer which comprises a module which runs on a server or computer and is responsible for extracting data from a loan origination system to said loan production system;
said management software system providing for conditions or stipulations to be added to a loan within said loan production system.

2. The system of claim 1 wherein access is given by said management software system to allow or disallow users from viewing certain documents in said loan production system.

3. The system of claim 1 wherein the management software system provides financial reporting, credit risk management, and enforces internal policies.

4. The system of claim 1 wherein said management software system enables paperless operations and electronic document and loan file storage.

5. The system of claim 1 wherein said management software system is a Sequel based system which overlays on top of any loan origination systems and accounting software systems.

6. The system of claim 1 wherein said management software system identifies efficient loan officers and monitors sales productivity.

7. The system of claim 1 wherein said management software system comprises dashboard management reporting and auto reporting.

8. The system of claim 1 wherein said management software system integrates an Outlook email system into custom designed notifications and messages/alerts that said management software system auto generates as directed and configured to match company organization chart and departmental structures and roles.

9. The system of claim 1 wherein said management software system is a fully web based system with a SQL database on the back end.

10. The system of claim 1 wherein said data importer uses a mapping of fields defined by a system administrator.

11. The system of claim 1 wherein said condition comprises when said condition needs to be satisfied, and who said condition is meant for are assigned to each condition.

12. The system of claim 1 wherein required documents for each condition are uploaded directly to said condition.

13. The system of claim 1 wherein an underwriter enters said management software system and either rejects, receives or clears a loan document.

14. The system of claim 1 further comprising a conditions admin which creates templates of conditions which a user applies to a loan to speed up process rather than select each condition.

15. The system of claim 1 further comprising an attachments module, a container for all scanned images for a loan.

16. The system of claim 1 wherein an image is uploaded directly to a condition where it is linked to said condition.

17. The system of claim 1 further comprising a Compliance/Business Rules/Signoffs module, which verifies all data for approval, closing and funding to a borrower.

18. The system of claim 17 wherein said Compliance/Business Rules/Signoffs module has validation which includes state subprime rules, HVCC (Home Value Code of Conduct), HMDA (Home Mortgage Disclosure Act), MDIA (Mortgage Disclosure Improvement Act) loan officer state licensing.

19. The system of claim 17 wherein said system provides warnings displayed for certain business rules.

20. The system of claim 17 further comprising appraisal signoffs.

21. The system of claim 17 wherein all data for loan to be summarized, and also be contained in email alerts, and a snapshot loan summary attached to loan in attachments and e-mailed to all parties on loan once a signoff is completed.

22. The system of claim 1 further comprising a refer decision module, which comprises a worksheet to send a loan for review by committee when an underwriter cannot make a final decision on said loan.

23. The system of claim 1 further comprising an appraisal review module, which comprises an appraisal review worksheet, appraisal conditions, and property information.

24. The system of claim 23 wherein a copy of said appraisal review is attached to said loan, and emailed to parties on said loan.

25. The system of claim 1 further comprising a title review module, which comprises a worksheet with title issues, deed information, departmental.

26. The system of claim 25 wherein said title review module gets attached to said loan in attachments and emailed to parties on said loan, once completed.

27. The system of claim 1 further comprising an HVCC module for tracking when an appraisal was sent to a borrower and how it was sent.

28. The system of claim 1 further comprising a compliance tracking module, which tracks when disclosure documents are sent and when loan can proceed, and/or when significant events, money collected for appraisal or other service from borrower, occurs within loan cycle.

29. The system of claim 1 further comprising a closing schedule module used to add and remove loans from a Closing Schedule report.

30. The system of claim 29 wherein said closing schedule module is color-coded to coordinate outcomes of a closing, such as, closed, released, rescinded, or adjourned).

31. The system of claim 1 further comprising a rate lock module, which is used by a lock desk for tracking which investor a loan is locked with.

32. The system of claim 31 wherein said rate lock module includes date loan was locked, the date said lock expires, trade, and what market was at time of lock.

33. The system of claim 31 wherein said rate lock module has an associated rate lock report displaying all loans not sold to an investor with rate lock expiration information.

34. The system of claim 1 further comprising a secondary module, which tracks multiple investor's pricing with a full breakdown as follows:
Base Price+Adjustments+SRP+Additional Premium=Price Price−Margin=Loan Officer Price.

35. The system of claim 1 further comprising a settlement module, which tracks warehouse information for closed loans.

36. The system of claim 1 further comprising tracking all monthly mortgage payments, next due date, monthly escrow for taxes and insurance and late payment information while interim servicing.

37. The system of claim 1 further comprising a post closing module, which tracks loan from closing to sale to an investor.

38. The system of claim 37 wherein said post closing module further includes closing, electronic delivery, assignment, and recording information.

39. The system of claim 1 further comprising a funding module, which captures sale date and pricing to an investor.

40. The system of claim 39 wherein information from funding module is used to calculate corporate revenue reports.

41. The system of claim 1 further comprising a MIC module which tracks FHA case binders delivered to HUD.

42. The system of claim 1 further comprising email alerts sent to all parties on a loan.

43. A method for managing loans comprising:
extracting data from a loan origination system and placing said data in a loan production system;
adding conditions or stipulations to said loan;
checking that said loan complies with regulatory changes through a business rule enforcement system;
verifying data for approval, closing and funding to a borrower.

44. The method of claim 43 further comprising allow or disallowing access to users for viewing certain documents in said loan production system.

45. The method of claim 43 further comprising:
identifying efficient loan officers and monitoring sales productivity.

46. The method of claim 43 further comprising:
integrating an Outlook email system into custom designed notifications and messages/alerts that said system auto generates as directed and configured to match company organization chart and departmental structures and roles.

47. The method of claim 43 further comprising:
creating templates of conditions which a user applies to a loan to speed up process rather than select each condition.

48. The method of claim 43 further comprising:
tracking when disclosure documents are sent and when loan can proceed, and/or when significant events, money collected for appraisal or other service from borrower, occurs within loan cycle.

49. The method of claim 43 further comprising:
adding and removing loans from a closing schedule report.

50. The method of claim 43 further comprising:
tracking which investor a loan is locked with, and tracking multiple investor's pricing with a full breakdown.

51. The method of claim 43 further comprising:
tracking all monthly mortgage payments, next due date, monthly escrow for taxes and insurance and late payment information while interim servicing.

52. The method of claim 43 further comprising:
tracking loans from closing to sale to an investor.

53. The method of claim 43 further comprising:
calculating corporate revenue reports.

54. The method of claim 43 further comprising:
tracking FHA case binders delivered to HUD.

55. The method of claim 43 further comprising sending email alerts to all parties on a loan.
